(19) United States
(12) Patent Application Publication
(10) Pub. No.: US 2020/0150639 A1
(43) Pub. Date: May 14, 2020

(54) PLANT INSPECTION PLANNING OPTIMIZATION APPARATUS AND METHOD THEREFOR

(71) Applicant: Hitachi, Ltd., Tokyo (JP)

(72) Inventor: Kazuo MUTO, Tokyo (JP)

(21) Appl. No.: 16/575,534

(22) Filed: Sep. 19, 2019

(30) Foreign Application Priority Data
Nov. 9, 2018 (JP) 2018-211303

(51) Int. Cl. G05B 19/418

(52) U.S. Cl. CPC G05B 19/41885; G05B 2219/37448

(57) ABSTRACT

A plant inspection planning optimization apparatus includes: a plant operation estimation unit that estimates the variation of the operation of a plant; a degradation probability distribution estimation unit that estimates the probability distributions of the degradations of plural inspection-scheduled points of the plant with the use of the variation of the operation of the plant and the degradation state and the probability distribution of the parameter of an estimation model obtained at the previous inspection; an inspection point optimization unit that selects inspection points selected from the inspection-scheduled points in accordance with a selection index with the use of the probability distributions of the degradations of the plural inspection-scheduled points; and an output unit that provides the selected inspection points and inspection techniques.

### CLAIM OF PRIORITY

The present application claims priority from Japanese Patent Application JP 2018-211303 filed on Nov. 9, 2018, the content of which are hereby incorporated by references into this application.

### TECHNICAL FIELD

The present invention relates to supporting the operations of various plants for electric power generation, medicine manufacture, chemistry, and the like, and more particular relates to a plant inspection planning optimization apparatus and a method therefor with the use of a model for estimating the degradations of plants.

### BACKGROUND

In each of large-scale plants such as chemical/petroleum plants, electric power generation plants, there are several thousands to several tens of thousands of points on which periodic inspections should be performed, which leads to a large amount of the cost of a periodic inspection. In addition, since it becomes necessary to temporarily stop the operation of a plant when the inspection of the plant is performed, a large amount of loss owing to the stoppage of the plant during the inspection is caused. Therefore, the necessity to reduce the costs and man-powers of the periodic inspections of various kinds of plants has been claimed.

In response to such necessity, a method in which the inspection times and update times of respective devices included in a plant are set on the basis of information about actual usage records of the respective devices is proposed in Japanese Unexamined Patent Application Publication No. 2014-139774.

Furthermore, Japanese Unexamined Patent Application Publication No. 2004-191359 discloses a technology in which the failure probability distributions of respective devices included in a plant are modified with reference to the relevant inspection data and the inspection times and update times for the respective devices are optimized.

### SUMMARY

Both Japanese Unexamined Patent Application Publications Nos. 2014-139774 and 2004-191359 propose technologies in which a model for estimating the probability distribution of the degradations and residual lifetimes of devices on the basis of the past achievement data and public information are built and planning for performing these inspections and updates is optimized using this model.

In this case, although it is necessary to take the uncertainties of the future operation conditions of plants into consideration when the probability distributions of the degradations and residual lifetimes of the devices are respectively estimated, the above uncertainties are not taken into consideration in the methods described in Japanese Unexamined Patent Application Publications Nos. 2014-139774 and 2004-191359.

In addition, the probability distributions of the degradations and residual lifetimes are modified using measurement data, but the estimation model is not updated, so that if the estimation model is inaccurate, the accurate probability distributions of the degradation and residual lifetime cannot be estimated.

For the abovementioned reason, it is impossible to accurately estimate the probability distributions of the degradations and residual lifetimes in the future when the methods described in Japanese Unexamined Patent Application Publications Nos. 2014-139774 and 2004-191359 are adopted.

The present invention has been achieved with the above situation borne in mind, and it provides a plant inspection planning optimization apparatus and a method therefor in which, after the uncertainties of the degradation states of devices owing to the estimation model are quantified with the uncertainties of the future operation conditions of plants taken into consideration, inspection points and inspection techniques are optimized in view of risks accompanying the failures of the devices, the improvement of the accuracy of the estimation model, and an inspection cost while taking account of the quantified uncertainties of the degradation states. Next, the improvement of the estimation model is accomplished using measurement data obtained through the abovementioned inspections.

In order for the above items to be satisfied, the present invention provides “a plant inspection planning optimization apparatus includes: a plant operation estimation unit that estimates the variation of the operation of a plant; a degradation probability distribution estimation unit that estimates the probability distributions of the degradations of plural inspection-scheduled points of the plant with the use of the variation of the operation of the plant and the degradation state and the probability distribution of the parameter of an estimation model obtained at the previous inspection; an inspection point optimization unit that selects inspection points selected from the inspection-scheduled points in accordance with a selection index with the use of the probability distributions of the degradations of the plural inspection-scheduled points; and an output unit that provides the selected inspection points and inspection techniques”.

Furthermore, the present invention provides “a method for optimizing plant inspection planning including the steps of: estimating the variation of the operation of a plant; estimating the probability distributions of the degradations of the plural inspection-scheduled points of the plant with the use of the variation of the operation of the plant and the degradation state and the probability distribution of the parameter of the estimation model obtained at the previous inspection; selecting inspection points selected from the inspection-scheduled points in accordance with a selection index with the use of the probability distributions of the degradations of the plural inspection-scheduled points; and providing the selected inspection points and inspection techniques.

According to the present invention, since the inspection planning of a plant is made on the basis of an estimation made in consideration of the uncertainty of the future operation condition of the plant, the reduction of the cost and manpower in a more accurate plant inspection can be achieved.

### BRIEF DESCRIPTION OF THE DRAWINGS

FIG. 1 is a diagram showing a configuration example of a plant inspection planning optimization apparatus according to the present invention;

FIG. 2 is a diagram showing the connections and processing interactions among respective processing functions in an arithmetic processing unit 103;

FIG. 3 is a diagram showing a detail configuration example of an inspection planning optimization unit 107;

FIG. 4 is a flowchart showing the overall processing of a plant inspection planning optimization apparatus 100 with its concrete configuration examples shown in FIG. 2 and FIG. 3;

FIG. 5 is a diagram showing an example of a display screen on which a tradeoff adjustment parameter is set; and

FIG. 6 is a diagram showing an example of a display screen on which inspection points and inspection techniques optimized by the inspection planning optimization unit 107 are displayed.

### DETAILED DESCRIPTION

Next, an embodiment of the present invention will be explained in detail referring to the accompanying drawings accordingly.

### Embodiment

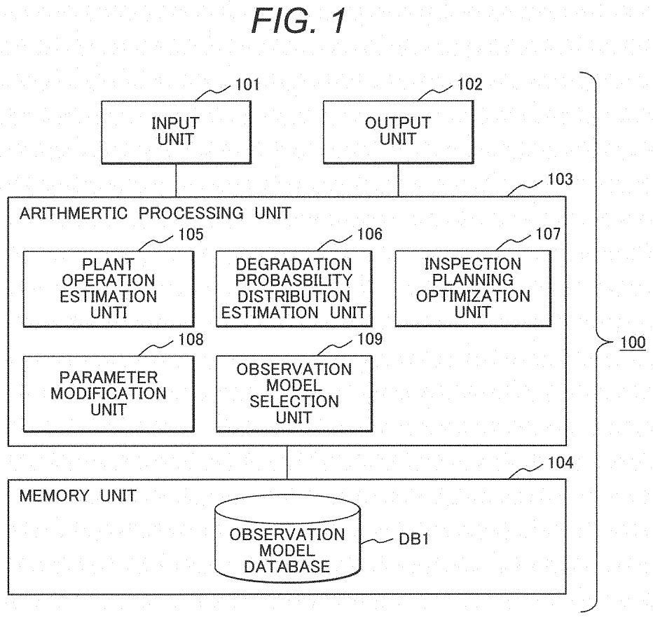

FIG. 1 is a diagram showing a configuration example of a plant inspection planning optimization apparatus according to the present invention. Here, the plant inspection planning optimization apparatus according to the present invention provides information for assisting inspection planning decision conducted by an inspector using its functions, therefore the plant inspection planning optimization apparatus itself can be referred to as a plant operation assistance apparatus.

The plant inspection planning optimization apparatus 100 is composed by a computer system, and it includes: an input unit 101; an output unit 102; an arithmetic processing unit 103; and a memory unit 104.

Among these units, the input unit 101 is an input device such as a keyboard, a mouth, or the like, and it is used when a user of the plant inspection planning optimization apparatus 100, for example, the inspector, inputs some kind of data into the plant inspection planning optimization apparatus 100, or when he/she inputs sensor data or the like obtained from control devices of a plant into the plant inspection planning optimization apparatus 100.

The output unit 102 is an output device such as a display device, and it displays the processes and results of pieces of processing performed by the arithmetic processing unit 103 and a screen for showing pieces of interactive processing for a user of the plant inspection planning optimization apparatus 100.

The memory unit 104 is memory means such as a hard disk in concrete terms, and it includes an observation model database DB1 and the like. The observation model database DB1 stores observation model data corresponding to inspection techniques and inspection points. Here, an observation model is a mathematical model representing a relationship between measurement data obtained by a specific inspection technique at a specific inspection point and the degradation state of a plant. Therefore, the observation model database DB1 includes a group of observation models which are prepared for each inspection point and measurement data regarding the group of observation models.

The arithmetic processing unit 103 is a CPU (Central Processing Unit) in concrete terms, and it performs information processing in the plant inspection planning optimization apparatus 100. Processing contents executed in the arithmetic processing unit 103 are shown functionally in FIG. 1, and the arithmetic processing unit 102 includes: a plant operation estimation unit 105; a degradation probability distribution estimation unit 106; an inspection planning optimization unit 107; a parameter modification unit 108; and an observation model selection unit 109.

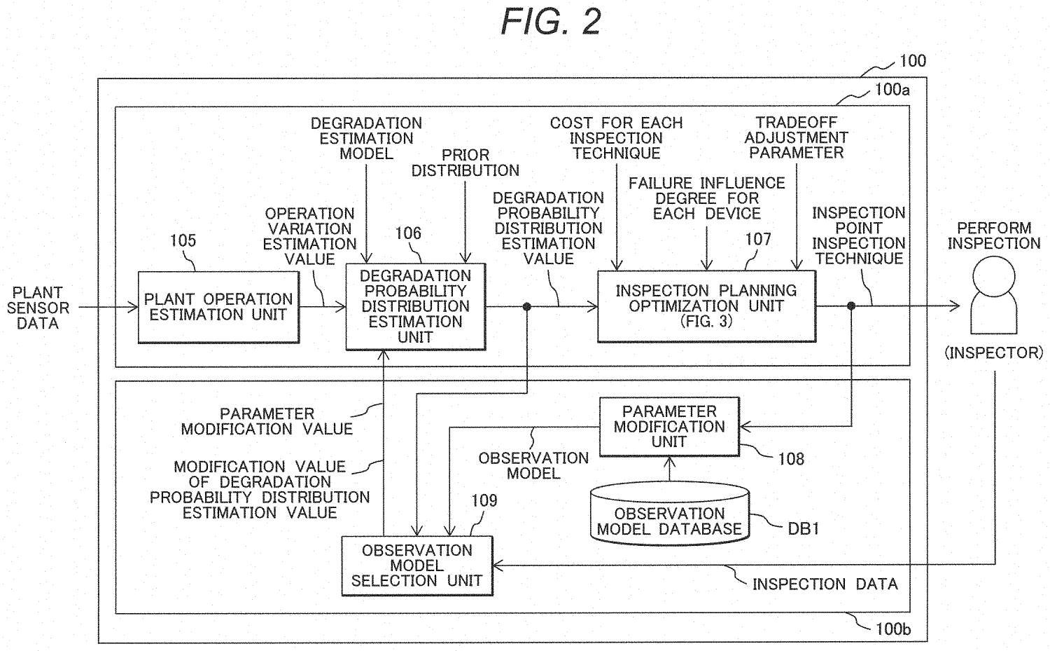

FIG. 2 is a diagram showing the connections and processing interactions among respective processing functions in the arithmetic processing unit 103, and the respective processing functions and the interactions therebetween will be explained with reference to FIG. 2 below. Here, the functions shown in FIG. 2 is realized by a plant inspection planning optimization section 100a that proposes optimal plant planning and a plant inspection planning optimization modification section 100b that modifies inspection planning and optimizes the inspection planning, so that it can be concluded that the plant inspection planning optimization section 100a and the plant inspection planning optimization modification section 100b collaboratively compose the plant inspection planning optimization apparatus 100.

The plant inspection planning optimization section 100a includes the plant operation estimation unit 105, the degradation probability distribution estimation unit 106, and the inspection planning optimization unit 107.

Among the units included in the plant inspection planning optimization section 100a, the plant operation estimation unit 105 estimates the operation state of the plant and the variation of the operation state after the previous inspection as an operation variation estimation value from sensor data regarding the operation of the plant obtained by the control devices of the plant and the like. The operation state and its variation are represented as a probability distribution.

Information from a degradation estimation model (the probability distribution of the parameter of the degradation estimation model) and information regarding the prior distribution (the degradation state of the plant at the previous inspection) as well as the operation variation estimation value from the plant operation estimation unit 105 are input into the degradation probability distribution estimation unit 106. From the degradation state of the plant, the probability distribution of the parameter of the degradation estimation model, the operation state of the plant, and the probability distribution of the operation state that represents the variation of the operation state of the plant at the previous inspection, the degradation probability distribution estimation unit 106 estimates the probability distribution of the degradation state using the degradation state and the estimation model, and sets the estimated probability distribution of the degradation state as a degradation probability distribution estimation value.

Here, in the case where the degradation state of a plant and the probability distribution of a parameter at the previous inspection cannot be obtained such as in the case of the first inspection, design data regarding the plant, data regarding a similar kind of plant, and the like are set as the degradation state of the plant and the probability distribution (the prior distribution) of the parameter.

In addition, the degradation probability distribution estimation unit 106 obtains a parameter modification value from the parameter modification unit 108 in the after-mentioned plant inspection planning optimization modification section 100b, and uses the parameter modification value for modifying the degradation probability distribution estimation value.

The inspection planning optimization unit 107 obtains information about a cost for each inspection technique, a failure influence degree for each device, and a tradeoff adjustment parameter in advance as well as the degradation probability distribution estimation value from the degradation probability distribution estimation unit 106.

The inspection planning optimization unit 107 optimizes inspection points and inspection techniques on the basis of the costs for inspection techniques, the failure influence degrees of devices composing an inspection-target plant, the tradeoff adjustment parameter representing what high values are respectively attached to data acquisition for the improvement of the accuracy of a physical model from the estimation of the probability distribution of the degradation state of the plant, and displays information regarding the optimized inspection points and inspection techniques on a display device or the like that is the output unit 102 to provide the information to the inspector.

A user of the plant inspection planning optimization apparatus 100 such as the inspector actually performs inspection with reference to the inspection points and inspection techniques, which are provided by the plant inspection planning optimization section 100a, and inputs inspection data, which is the results of the inspection, into the plant inspection planning optimization apparatus 100.

The plant inspection planning optimization modification section 100b includes the observation model selection unit 109, the observation model database DB1, and the parameter modification unit 108.

In the plant inspection planning optimization modification section 100b, the observation model selection unit 109 selects an appropriate observation model from the observation model database DB1 on the basis of the inspection points and inspection techniques output from the inspection planning optimization unit 107. In other words, the observation model selection unit 109 selects observation models corresponding to the specified inspection points and the measurement data regarding the observation models from the observation model database DB1 that includes groups of observation models for the respective inspection points and measurement data regarding the group of observation models.

The parameter modification unit 108 brings in the inspection data given by the inspector, the observation model from the observation model selection unit 109, and the degradation probability distribution estimation value from the degradation probability distribution value estimation 106, and calculates a parameter modification value and a degradation probability distribution modification value used for modifying the parameter and degradation probability distribution of the degradation estimation model on the basis of these data pieces. Here, the parameter modification value and the degradation probability distribution modification value are given to the degradation probability distribution estimation unit 106 in the plant inspection planning optimization section 100a, and they are used for modifying the parameter and the degradation probability distribution. For modifying the parameter and the degradation probability distribution, a Bayes estimation method is used, for example.

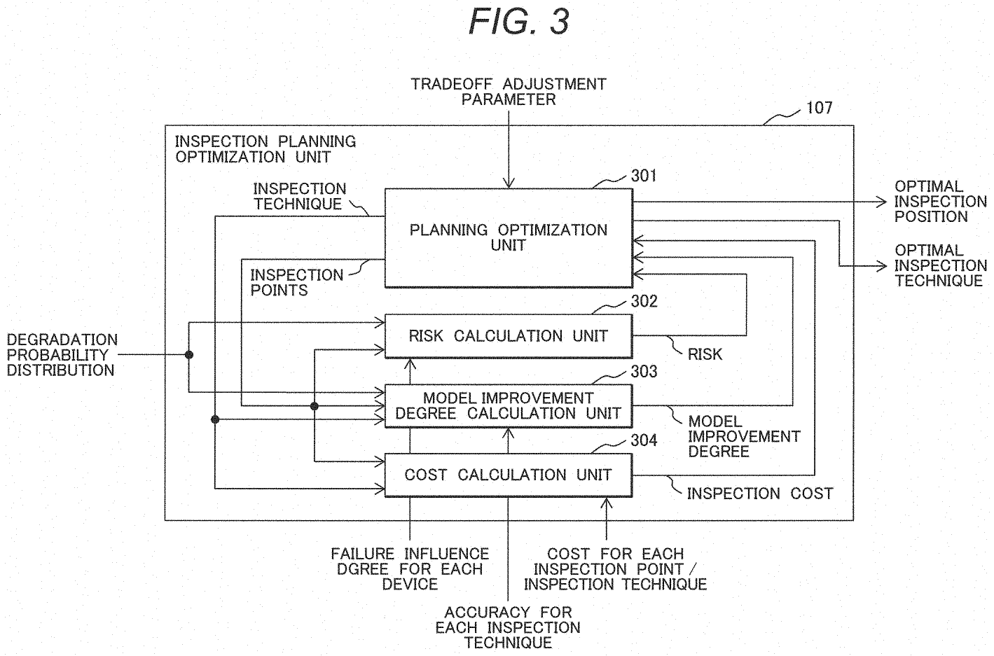

FIG. 3 shows a detail configuration example of the inspection optimization planning optimization unit 107. The inspection planning optimization unit 107 includes a planning optimization unit 301, a risk calculation unit 302, a model improvement degree calculation unit 303, and a cost calculation unit 304.

The planning optimization unit 301 optimizes the inspection points and inspection techniques on the basis of risks calculated by the risk calculation unit 302, an index for model improvement calculated by the model improvement degree calculation unit 303, an inspection cost calculated by the cost calculation unit 304, and information regarding the tradeoff adjustment parameter set in advance, and outputs these values.

In the abovementioned function of the planning optimization unit 301, all the inspection points of assumed plural inspection points are not provided to the inspector as inspection-target points, but in view of a risk in the case where inspections are not performed about some inspection points and a cost in the case where inspections are actually performed about the other inspection points, combinations of inspection points on which inspections are actually performed and the corresponding inspection techniques are provided to the inspector in such a way that the combinations make both risk and cost satisfactory. Furthermore, in the abovementioned function of the planning optimization unit 301, the index for model improvement are also regarded as factors to be taken into consideration in the selection of inspection points and inspection techniques.

The outputs of the planning optimization unit 301 are used to be visually provided to an inspector, information regarding the inspection points is provided for processing in the risk calculation unit 302, the model improvement degree calculation unit 303, and the cost calculation unit 304, and information regarding the inspection techniques is provided for processing in the model improvement degree calculation unit 303 and the cost calculation unit 304.

The risk calculation unit 302 calculates a risk by calculating the product of a failure influence degree brought about when a device composing a plant fails (which is given, for example, from information externally set in advance) and a degradation probability distribution corresponding to the device (which is output from the degradation probability distribution estimation unit 106).

In addition, when the risk is calculated, information regarding the inspection points calculated in the planning optimization unit 301 is used. Here, for example, it can be concluded that, if the radial thickness of a pipe at an inspection point is thin, there is a high possibility that the pipe will be broken before the next inspection, so that it is highly necessary to inspect the inspection point at the next inspection, and it can be concluded that, if the radial thickness of a pipe at an inspection point is sufficiently thick, it is not highly necessary to inspect the inspection point at the next inspection.

The model improvement degree calculation unit 303 calculates an index showing how much the accuracy of the model is improved (a model improvement degree) using the inspection points and inspection techniques given by the planning optimization unit 301. For example, the sum of the variances of the degradation probability distributions of the given inspection points is adopted as the index. Here, there are some combinations of inspection points and inspection techniques that heighten the model improvement degree, and there are other combinations of inspection points and inspection techniques that do not contribute to the model improvement degree. In the calculation of model improvement degrees, the accuracy of the inspection technique of each device (which is externally set in advance, for example) and the degradation probability distribution for each device (which is output from the degradation probability distribution estimation unit 106).

The cost calculation unit 304 calculates the cost needed for the inspection with reference to the inspection points and inspection techniques given by the planning optimization unit 301. There are some cases where some inspection points require special inspection techniques, so that a lot of hours and expenses are required for the special inspection techniques, and on the other hand there are other cases where other inspection points can be inspected with common and simple techniques and at low costs. In the abovementioned cost calculation, information regarding a cost for each combination of an inspection point and an inspection technique (which is externally set in advance, for example) is used.

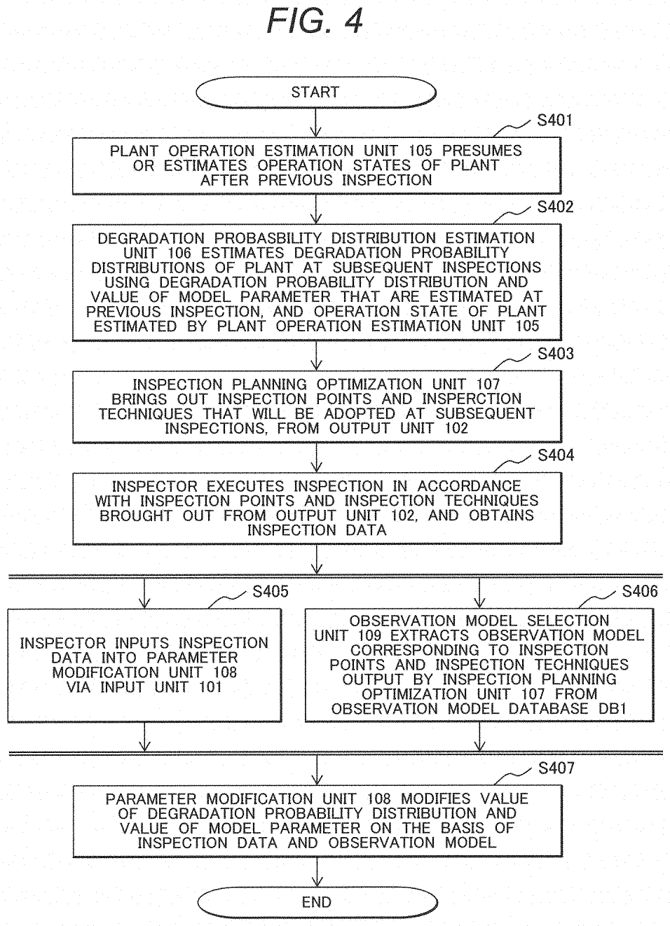

FIG. 4 is a flowchart showing the overall processing of the plant inspection planning optimization apparatus 100 the concrete configuration examples of which are shown in FIG. 2 and FIG. 3.

In the following explanation using this flowchart, a concrete plant will be illustrated, and the plant will be explained concretely using various physical quantities and mathematical equations. It will be assumed that the concrete plant is an industrial plant such as an electric power generation plant, a chemical plant, or a pharmaceutical plant, and the inspection of the pipe arrangement of this industrial plant is performed. The number of the inspection points of the pipe arrangement of the industrial plant ranges from several hundreds to several tens of thousands, and the inspection cost for the inspection points becomes very high. Furthermore, it becomes necessary to stop the operation of the plant during the inspection, so that a loss regarding the stoppage of the plant is added to the above inspection cost. Therefore, it is important to reduce the number of the inspection points of the pipe arrangement.

When it comes to the optimization of the inspection planning of the pipe arrangement, a main cause of the degradation of the pipe arrangement is the decrease of the radial thicknesses of the pipes included in the pipe arrangement. Therefore, in this application example, in the case where a model using which the residual radial thicknesses of the pipes can be estimated from the operation state of the plant is given, a plant inspection planning optimization apparatus that optimizes the inspection planning of the pipe arrangement in consideration of the uncertainties of the model is discussed.

In this application example, it will be assumed that the optimization of the t^{th} inspection is discussed. Here, the residual radial thickness xₜ₋₁ of the pipe arrangement at the time of the t−1^{th} inspection is represented by an expression xₜ₋₁=[xₜ₋₁(ξ₁), xₜ₋₁(ξ₂), . . . , xₜ₋₁(ξₙ)]. Here, ξᵢ shows the i^{th} inspection point of the pipe arrangement, and xₜ(ξᵢ) is a residual radial thickness of a pipe at the inspection point ξᵢ. In addition, it will be assumed that, if an operation condition u_{t-1:t} during a period between the t−1^{th} inspection and the t^{th} inspection is given, a model xₜ=f(xₜ, u_{t-1:t}, θ) that estimates xₜ=[xₜ(ξ₁), xₜ(ξ₂), . . . , xₜ(ξₙ)] is given, where xₜ₋₁ represents a residual radial thickness of the pipe arrangement at the t^{th} inspection. Here, θ is a parameter of a physical model θ.

Assuming that the abovementioned application example is used for a prerequisite for the following discussion, as shown at Processing Step S401 in a flowchart in FIG. 4, the plant operation estimation unit 105 estimates the operation states of the plant after the previous inspection, and outputs the probability distributions of the operation states.

In this application example, first the plant operation estimation unit 105 calculates the probability distribution p(u_{t-1:t}) of the operation condition u_{t-1:1} using sensor data obtained from a plant control device and the like during the period between the t−1^{th} inspection and the t^{th} inspection. In addition, the plant operation estimation unit 105 estimates the probability distribution p(u_{t:t+1}) of a future operation condition u_{t:t+1} during the period between the t^{th} inspection and a t+1^{th} inspection using past sensor data. In the following descriptions, two probability distributions p(u_{t-1:1}) and p(u_{t:t+1}) are denoted by one probability distribution p(u_{t-1:t+1}).

In the processing performed by the plant operation estimation unit 105, to be brief, even if it is assumed that the past operation condition u_{t-1:t} (during the period between the t−1^{th} inspection and the t^{th} inspection) that exerts influence on the residual radial thicknesses of the pipes can be applied in the future, it does not necessarily mean that the operation condition u_{t-1:t} can be actually applied to a period until the next inspection in the future (a period between the t^{th} inspection and the t+1^{th} inspection), the range of the variation of the future operation condition is estimated. The variation of an operation condition includes the changes of an operation condition represented by the change of operation hours for a unit time (for a month, for example), the changes of process quantities such as operation temperatures, operation pressures, operation loads, the replacement of devices included in the plant, the changes of the characteristics of the devices brought about by the maintenance of the devices, and it can be concluded that the probability distribution p(u_{t:t+1}) of the future operation condition u_{t:t+1}) is the variation of the operation of the plant calculated using the abovementioned variable factors.

Next, in the degradation probability distribution estimation unit 106, as shown at Processing Step S402 in the flowchart in FIG. 4, the degradation probability distributions of the plant at the subsequent inspections are estimated using the degradation (the prior distribution in FIG. 2) and the probability distribution of the parameter of the degradation estimation model that are estimated at the previous inspection, and the probability distribution of the operation state of the plant (the operation variation estimation value shown in FIG. 2) estimated by the plant operation estimation unit 105.

Here, in an concrete example of this case, the degradation estimated at the previous inspection (the prior distribution in FIG. 2) is a probability distribution p(xₜ₋₁, θ/yₜ₋₁) of the residual radial thicknesses and the parameter estimation value at the t−1^{th} inspection, the probability distribution of the parameter of the degradation estimation model is a physical model xₜ=f(xₜ₋₁, u_{t-1:t}, θ), and the probability distribution of the operation state of the plant (the operation variation estimation value shown in FIG. 2) estimated by the plant operation estimation unit 105 means the probability distribution p(u_{t-1:t+1}).

In the process of the degradation probability distribution estimation unit 106 shown in Processing Step S402, a residual radial thickness probability distribution p(xₜ, |yₜ₋₁) at the t^{th} inspection and a residual radial thickness probability distribution p(xₜ+, |yₜ₋₁) at the t+1^{th} inspection are calculated using the probability distribution p(u_{t-1:t+1}), the physical model xₜ=f(xₜ₋₁, u_{t-1:t}, θ), and the probability distribution p(xₜ₋₁, θ/yₜ₋₁) of the residual radial thicknesses and the parameter estimation value at the t−1^{th} inspection.

Here, yₜ is measurement data at the t^{th} inspection, and the above probability distribution p(A|B) represents a conditional probability of A in the case of B being given (where B represents yₜ₋₁ and A represents xₜ or xₜ+₁ in the above case). To put it concretely, an integral shown in Equation (1) is calculated.

[Equation (1)]

p(xₜ,xₜ₊₁,θ|yₜ₋₁)=∫ᵤ_{_{t−1:t+1}}∫ₓ_{ₜ}p(xₜ,xₜ₊₁|θ,xₜ₋₁,u_{t-1:t+1})p(xₜ₋₁,θ|yₜ₋₁)p(u_{t-1:t+1})dxₜdu_{t-1:t+1} (1)

Next, p(xₜ, |yₜ₋₁) and p(xₜ₊₁, |yₜ₋₁) are calculated using Equation (2) and Equation (3) respectively.

[Equation 2]

p(xₜ|yₜ₋₁)∫_{θ}ƒₓ_{ₜ₊₁}p(xₜ,xₜ₊₁,θ|yₜ₋₁)dxₜ₊₁dθ (2)

[Equation 3]

p(xₜ₊₁|yₜ₋₁)∫_{θ}ƒₓ_{ₜ}p(xₜ,xₜ₊₁,θ|yₜ₋₁)dxₜdθ (3)

Here, p(xₜ, xₜ₊₁|, xₜ₋₁, u_{t-1:t+1}) included in Equation (1) is a probability model built from the physical model. For example, it will be assumed that p(xₜ, xₜ₋₁, u_{t-1:t}, θ) can be written using the physical model shown by Equation (4).

[Equation 4]

p(xₜ|xₜ₋₁,u_{t-1:t}θ)˜Nₙ(f(xₜ₋₁,u_{t-1:t}θ),σ_{w}Iₙ) (4)

Here, Nₙ(μ, V) represents an n-dimensional multivariable normal distribution with an average μ and a variance V, and Iₙ represents an n×n unit matrix. By repeatedly executing Equation (4), Equation (5) is given.

[Equation 5]

p(xₜ,xₜ₊₁|θ,xₜ₋₁,u_{t-1:t+1})=p(xₜ₊₁|xₜu_{t+1:t},θ)p(xₜ|xₜ₋₁,u_{t-1:t},θ) (5)

Here, a relation u_{t-1:t}=[u^{T}_{t-1:t}, u^{T}_{t+1:t}] is used. In this case, u^{T}_{t-1:t} and u^{T}_{t+1:t} represent the transposed vectors of U_{t-1:t} and U_{t+1:t} respectively.

Next, as shown at Processing Step S403 in the flowchart in FIG. 4, the inspection planning optimization unit 107 brings out inspection points and inspection techniques that will be adopted at the subsequent inspections from the output unit 102 with reference to the estimation of the degradation probability distribution of the plant.

To put it concretely, for example, since the probability distributions of the residual radial thicknesses p(xₜ, yₜ₋₁) and p(xₜ+, |yₜ₋₁) are given by the inspection planning optimization unit 107, the residual radial thicknesses of plural inspection points of the pipe arrangement have already been estimated.

Therefore, at the next stage, although it is ideal to propose that inspections should be performed on all inspection-scheduled points of the pipe arrangement of the actual plant in order to verify the estimation values, it is desirable from a practical viewpoint to propose that verifications at all the inspection points should not be executed, but that verifications at optimally selected inspection points should be executed.

One of criteria of the selection is a criterion used for determining to which of the cost and the risk, which are elements having a tradeoff relation with each other, greater importance is given on the basis of the tradeoff adjustment parameter. Another of the criteria of the selection is a criterion used for selecting points, by inspecting which the improvement of the estimation accuracy of the estimation model can be expected, as inspection points. It can be concluded that an element regarding the tradeoff relation between the cost and the risk to which attention should be paid at the selection of inspection points, and an element regarding the estimation accuracy of the estimation model are selection indexes for selecting the inspection points. The selection index can be set in advance, and the inspection point can be selected in accordance with any of the abovementioned elements or in accordance with both elements.

Therefore, the inspection planning optimization unit 107 calculates optimal inspection points ξⱼ₁, ξⱼ₂, . . . , ξⱼₙ and the corresponding inspection techniques ξⱼ₂, ξⱼ₂, . . . , ξⱼₘ on the basis of a cost, influence on the operation of the plant when a leakage occurs in the pipe arrangement, and a tradeoff adjustment parameter for each inspection technique, where min. Furthermore, in a similar way, the inspection planning optimization unit 107 selects inspection points in such a way that the improvement of the estimation accuracy of an estimation model obtained from the results of inspections at the inspection points can be expected. Here, the selection of the inspection points can be done in view of the tradeoff or in view of the estimation accuracy, or the selection can be done in view of both tradeoff and estimation accuracy.

In the case of this application example, since a cost for each inspection technique and influence on the operation of the plant when a leakage occurs in the pipe arrangement can be grasped in advance, these can be input in advance into the inspection planning optimization unit 107. A tradeoff adjustment parameter can be set for each inspection by a user.

The inspection points and the inspection techniques finally selected in view of the costs and risks by the inspection planning optimization unit 107 are displayed on the output unit 102 (for example, a display device) that is attached to the plant inspection planning optimization apparatus 100. In addition, various pieces of information that have been set in advance by an inspector or a user are selectively displayed on the output unit 102, for example, so that these preset pieces of information can be input into the plant inspection planning optimization apparatus 100 via the input unit 101 (for example, via a keyboard or a touch panel).

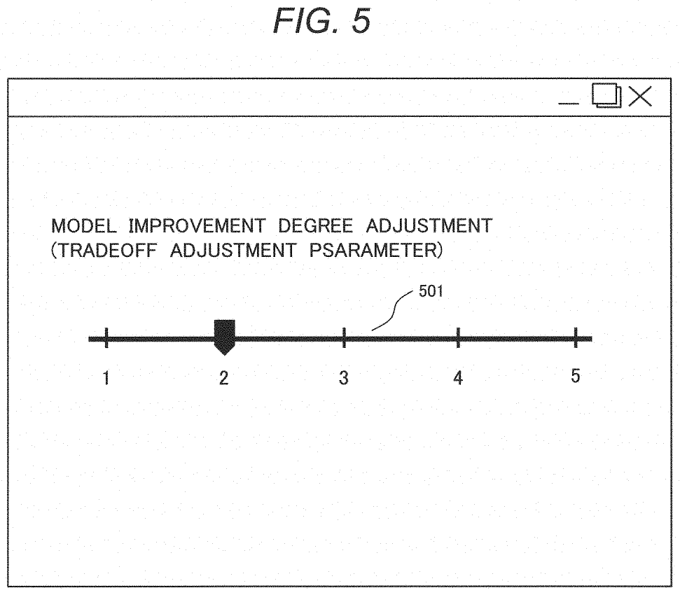

FIG. 5 shows an example of a display screen on which the tradeoff adjustment parameter is set as an example of a preset piece of information. FIG. 5 shows an example in which the value of the tradeoff adjustment parameter is adjusted between 1 and 5 using a slide bar 501. Here, the value 2 of the tradeoff adjustment parameter means that inspection points are evaluated in consideration of the costs given a weight 20% and the risks given a weight 80%. In other words, inspection points that are actually adopted are selected in consideration of the risks given a heavier weight.

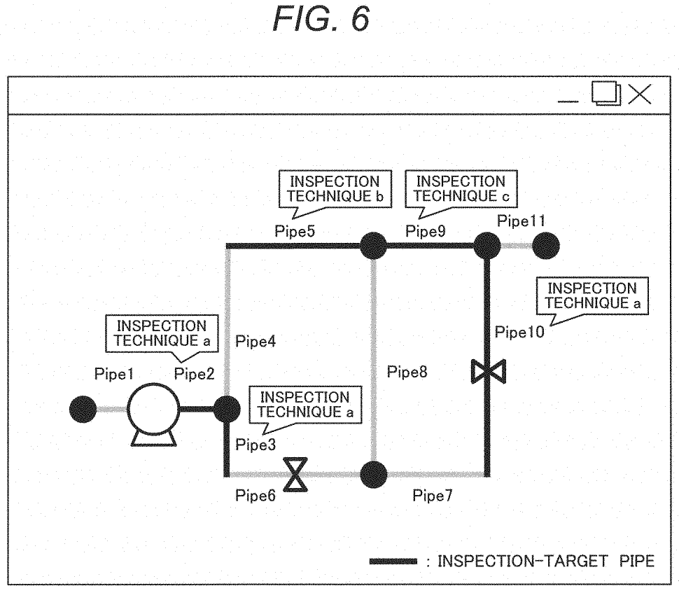

FIG. 6 shows an example of a display screen on which inspection points and inspection techniques optimized by the inspection planning optimization unit 107 are displayed. In this example, a pipe 2, a pipe 3, a pipe 5, a pipe 9, and a pipe 10 that are selected among inspection-target pipes (a pipe 1 to a pipe 11) are highlighted on a piping drawing (written in bold strokes in FIG. 6). Furthermore, an inspection technique is specified in a balloon for each of the selected pipes.

Returning to Processing Step S404 in FIG. 4, at Processing Step S404, the inspector performs inspections in accordance with the inspection points and inspection techniques brought out from the output unit 102, and he/she obtains inspection data yₜ=[yₜ(ξⱼ₁), yₜ(ξⱼ₂), . . . , yₜ(ξⱼₙ)].

Next, as shown at Processing Step S405, the inspector inputs the obtained data into the parameter modification unit 108 via the input unit 101.

In addition, as shown at Processing Step S406 in FIG. 4, the observation model selection unit 109 selects, from the observation model database DB1, an observation model yₜ=g(xₜ, θ) corresponding to the inspection points and inspection techniques output by the inspection planning optimization unit 107.

Next, as shown at Processing Step S407, the parameter modification unit 108 calculates the modification value p(xₜ|yₜ) of the residual radial thicknesses and the modification value p(θ|yₜ) of the probability distribution of the parameter on the basis of the inspection data yₜ and the observation model yₜ=g(xₜ, θ). To put it concretely, p(xₜ, θ|yₜ) is calculated from Equation (6) using Bayes theorem first.

[Equation 6]

p(xₜ,θ|yₜ)∝p(yₜ|xₜ,θ)p(xₜ,θ|yₜ₋₁) (6)

Next, the modification value p(xₜ|yₜ) of the residual radial thickness and the modification value p(θ|yₜ) of the probability distribution of the parameter are calculated from p(xₜ, θ|yₜ) using Equations (7) and (8) respectively.

[Equation 7]

p(xₜ|yₜ)=∫_{θ}p(xₜ,θₜ|yₜ)dθ (7)

[Equation 8]

p(θ|yₜ)=∫ₓ_{ₜ}(xₜ,θₜ|yₜ)dxₜ (8)

Here, p(yₜ|xₜ, θ) is a probability model built from the observation model, and, for example, it is conceivable that p(yₜ|xₜ, θ) is a model given by Equation 9.

[Equation 9]

p(yₜ|xₜ,θ)˜Nₘ(g(xₜ,θ),σ_{y}²Iₘ) (9)

Owing to a series of the above-described processing, the estimation accuracy achieved by the degradation probability distribution estimation unit 106 shown in FIG. 2 is improved, which contributes to the accuracy improvement at the next estimation. As described above, according to the present invention, since the inspection planning is made on the basis of an estimation made in consideration of the uncertainty of the future operation condition of the plant, the reduction of the cost and manpower of a more accurate plant inspection can be achieved.

### LIST OF REFERENCE SIGNS

100: plant inspection planning optimization apparatus
100a: plant inspection planning optimization section
100b: plant inspection planning optimization modification section
101: input unit
102: output unit
103: arithmetic processing unit
104: memory unit
105: plant operation estimation unit
106: degradation probability distribution estimation unit
107: inspection planning optimization unit
108: parameter modification unit
109: observation model selection unit
db1: observation model database
301: planning optimization unit
302: risk calculation unit
303: model improvement degree calculation unit
304: cost calculation unit

1. A plant inspection planning optimization apparatus comprising:
a plant operation estimation unit that estimates the variation of the operation of a plant;
a degradation probability distribution estimation unit that estimates the probability distributions of the degradations of a plurality of the inspection-scheduled points of the plant with the use of the variation of the operation of the plant and the degradation state and the probability distribution of the parameter of an estimation model obtained at the previous inspection;
an inspection point optimization unit that selects inspection points selected from the inspection-scheduled points in accordance with a selection index with the use of the probability distributions of the degradations of the plurality of the inspection-scheduled points; and
an output unit that provides the selected inspection points and inspection techniques.

2. The plant inspection planning optimization apparatus according to claim 1, wherein the plant operation estimation unit estimates the variation of the operation of the plant with the use of the sensor data of the plant.

3. The plant inspection planning optimization apparatus according to claim 1, wherein the inspection point optimization unit calculates costs for performing inspections on the inspection-scheduled points and influence degrees incurred by the failures of devices composing the inspection-target plant with the use of the probability distributions of the degradations of the plurality of the inspection-scheduled points, and the selection index is a tradeoff adjustment parameter between the costs and the influence degrees.

4. The plant inspection planning optimization apparatus according to claim 1, wherein the inspection point optimization unit calculates the estimation accuracy of the estimation model with the use of the probability distributions of the degradations of the plurality of the inspection-scheduled points, the selection index is the estimation accuracy, and among the inspection-scheduled points, some inspection-scheduled points which are expected to improve the estimation accuracy are selected as actual inspection points.

5. The plant inspection planning optimization apparatus according to claim 1, further comprising:
an input unit into which the result of an inspection performed by an inspector in accordance with the inspection points and the inspection techniques provided by the output unit is input; and
a parameter modifying unit that adjusts the degradation probability distribution estimation unit with the use of an observation model showing the characteristics of the inspection points provided by the output unit and the inspection result provided from the input unit.

6. The plant inspection planning optimization apparatus according to claim 5, wherein the parameter modifying unit modifies the probability distributions of the degradations and the probability distribution of the parameter in the degradation probability distribution estimation unit.

7. A method for optimizing plant inspection planning comprising the steps of:
estimating the variation of the operation of a plant;
estimating the probability distributions of the degradations of a plurality of the inspection-scheduled points of the plant with the use of the variation of the operation of the plant and the degradation state and the probability distribution of the parameter of an estimation model obtained at the previous inspection;
selecting inspection points selected from the inspection-scheduled points in accordance with a selection index with the use of the probability distributions of the degradations of the plurality of the inspection-scheduled points; and
providing the selected inspection points and inspection techniques.

8. The method for optimizing plant inspection planning according to claim 7, wherein the probability distributions of the degradations are modified with the use of the result of an inspection performed by an inspector in accordance with the provided inspection points and inspection techniques, and an observation model showing the characteristics of the provided inspection points.
